(19) United States
(12) Patent Application Publication
(10) Pub. No.: US 2004/0114990 A1
(43) Pub. Date: Jun. 17, 2004

(54) Device for fitting security gratings across doors and/or windows by means of telescopic elements

(76) Inventor: Pietro D' Andrea, Giacomo degli Schiavoni (IT)

Correspondence Address: YOUNG & THOMPSON, 745 SOUTH 23RD STREET 2ND FLOOR, ARLINGTON, VA, 22202

(21) Appl. No.: 10/471,738

(22) PCT Filed: Mar. 11, 2002
(86) PCT No.: PCT/IT02/00150

(30) Foreign Application Priority Data
Mar. 16, 2001 (IT) P101AOOO20

(51) Int. Cl. F16B 7/10

(52) U.S. Cl. 403/109.2

(57) ABSTRACT

The present invention consists of a device for fitting security gratings in a simple way, without any complicated walling operations and with no need of skilled workers. It permits to place a grating by means of two guides parallel each other, which represent the base and the top of the grating. Since they are provided with telescopic parts at their ends, they suit any span to be protected, ensuring a perfect fitting. This device and its fitting process can get, by the realization of an industrial product, the same effects obtained by the realization of a handmade product, but a very low costs and with considerable saving of time in fitting.

### DESCRIPTION

1. Technical Field

The present invention concerns the technical sector relating the construction and fitting of gratings to be placed across windows, doors and/or other openings. In particular, it relates to the technical sector relating the fitting of movable but stable gratings, for the protection of the opening they are applied to.

2. Background Art

At present, security gratings across doors and/or windows are known, whose structure is characterized by a border frame over which vertical and/or horizontal axes are soldered, or otherwise fixed; this structure is then placed across the opening by embedding part of it inside the wall next to the opening.

The fitting of said structure involves an inevitable destructive action on the spans to be protected, in order to permit the insertion of hinges, or any part forming the grating, inside the stonewall and successively embed the grating support to the wall.

This process entails, besides a huge manual labour, a particular attention to the grating being parallel and perpendicular compared with the span, which, as it often happens especially in non-recent buildings, can be geometrically not regular. Said system, which is at present the only one known, has also the relevant drawback of being very expensive and needing the work of a skilled worker. In addition, once the grating has been fitted in the aforesaid way, it's difficult to remove it from its position and place it elsewhere, and even if one decides to do it anyway, it's necessary to destroy the wall in the part where the hinges have been walled.

### DISCLOSURE OF INVENTION

The present invention aims at eliminating the above-mentioned and other drawbacks, supplying a fitting device essentially consisting of two telescopic elements, which support both the building part and the security grating, equipped with register elements that, if rotated, let the two sides of the telescopic parts lengthen, so that joining the ends of the span, they show the exact position of tracer for the drilling. Another facilitation is given by the eccentric construction of the supports, provided with this device, which will avoid possible linearity errors in the drilling. By analogous process, the upper element will be fixed by means of the double rotation of the register for the right and left extension, so as to correct the imperfections of the spans and to allow a perfect vertical alignment of the hinge and lock ferrules. Said system is still valid for different types of doors or windows, providing the appropriate building modifications that diversify the dimensions, but not the original solution of the invention.

The inventiveness and functionality of the present invention can be better understood by reading the following description and referring to the enclosed drawings.

Reduced to its essential structure and with reference to the figures of the enclosed drawings, a device for the construction and fitting of gratings, according to the invention, comprises:

Means to support the body of the grating, by a rectangular metallic tube (1) shorter than the horizontal or vertical span of the opening (2) across which it must be applied, which is the distance between the two horizontal or vertical jambs (3). Said tube is provided, along its longitudinal axis, with holes at a distance equivalent to the distance between hinge and lock of the window grating, inside which a number of metallic ferrules (4) are fitted, in order to contain the hinge and lock pivot and act as guide of the telescopic part of the device, since their length has been beforehand calculated to form inside a geometrically compatible guide (Sect. A-A of FIG. 2).

Means to regulate the length of the tube, by a notch (5) at the centre of the tube, where two registers (6, 7) are inserted, which have respectively fitted a spiral rod (8, 9) into the thread of the plugs (10, 11) comprised in the inner part of the components (12, 13) forming the extendable part of the system. These components, led both by the internal plane of the tubing body and, on the opposite side, by the ferrule (4) and the particular shape of the final part of the body of the invention, are pushed by independent rotation of the registers in extension or traction, so that these symmetrical movements allow a perfect position of the device at the centre of the span.

Means to block the registers, by two holes, made on the central body (1) at the vertical axis of the registers (6, 7), able to block them by means of screws or other means, thanks to a suitable spiral drilling (16) made on the same registers, without causing bulk on the upper part of the device, which will comprise the grating door and/or window.

Means to apply the tube on the sides of the opening across which the grating must be placed, by wall pivots, consisting of a lock pivot (17) to which a support (23) is fixed, which permits the alignment and therefore the insertion of the ends (19, 20) of the telescopic elements (13, 12) constituted by an open ferrule embedded inside their ends.

Conveniently, in order to support the grating, the tubes to be applied to the window or other similar opening, are at least two, both placed horizontally or vertically across the opening to be protected and parallel each other.

Conveniently, on the surface of the tubes facing the inside of the opening across which the grating must be applied, there are a number of ferrules (4) comprising the hinge and lock pivot of the grating. Said grating is constructed in such a way that it can be either kept always closed or opened like a normal window, acting on the axis fixed on the lock pivot that works also as releasing element of the lock (FIG. 7).

Conveniently, the two registers (6, 7) autonomously rotate, so allowing the user to extend or pull one of the two spiral rods (8, 9) without causing effect on the other or vice versa. Conveniently, the two registers (6, 7) can freely rotate around their central axis, causing the spiral rods (8, 9), joint to them, rotate either in one direction or in the other, respectively extending or pulling the elements (12, 13) connected to the ends of the rods opposite to the ones where the registers are applied.

Conveniently, once the registers have been rotated enough to make the spiral rods reach the desired extension, in order to avoid tampering or involuntary rotations, they are locked with suitable lock screws (15), type TSCE, which enter the holes (16) on the outer part of the same register.

Conveniently, the part of the tube where the lock screws are fixed is later covered with suitable metallic protection, in order to avoid tampering and not to alter the overall aesthetic of the tube.

Conveniently, in order to embed the tube in the wall, a lock pivot (17) must be applied to the wall on which the same tube must be fixed, being said pivot (17) possibly equipped, in the the walls are made of airbricks, with a clutch (18) that contains the injection of the pouring resin.

Conveniently, in order to avoid possible slight errors in the drilling, the support (23) has an eccentric hole (FIG. 4), so that, by rotating, it permits the perfect alignment and insertion of the final parts of the telescopic elements (19, 20), which consist of an open ferrule embedded and soldered inside their ends.

We are now going to describe the fitting process.

Once the telescopic element has been centred, like in FIG. 2, we proceed with the tracing necessary to locate the drilling point for fixing the pivots to the wall. Rotating the registers, the telescopic parts will extend outside up to their insertion in the supports (FIG. 5).

In order to fit the upper telescopic element, the same grating (21) is used as natural locating apparatus. FIG. 6 shows how, by similar process, problems of alignment are solved, thanks to the possibility of the device to move independently along the horizontal axis, positioning in perfect vertical alignment for hinge and lock.

The versatility of the device is demonstrated in FIGS. 7, 8, 9, 10 showing how this device can naturally suit several types of doors and/or windows, only by providing different position and number of the hinge/lock ferrules. FIG. 7 shows the fitting of a security grating across a simple one-shutter window. FIG. 8 shows the fitting of the same grating by a different method, using a third telescopic element (22) forming an upper fixed part. Even if in this case it's necessary to align three points per axis, the device will avoid possible errors of parallelism between the walls thanks to its automatic regulation.

Conveniently, the fitting of a security grating, according to the present invention, is carried out by means of two telescopic elements acting as fixing and supporting base of the same grating, through the following phases.

We insert, in the lower part of the opening, the telescopic element forming the base, which consists of a metallic section properly shaped and aesthetically compatible with the grating. We proceed extending the telescopic parts towards the walls, by means of two independent never-ending screw devices placed inside them. These elements, reaching the walls, acts as tracer for the following drilling that will be carried out avoiding possible linearity errors by means of the eccentric holes over the support connecting the telescopic element to the pivot fixed at the end. Then, once the spiral rod or sleeve has been inserted on the sides, we wait for the complete hardening of the suitable resin. The following insertion of the telescopic element will allow the lock of the same to the wall by means of the suitable registers. In a similar way, placing the shutter forming the grating on the fitted lower telescopic element, we'll proceed placing the upper telescopic element into the specific holes along the longitudinal axis of the device, properly equipped with metallic embedded ferrule that will act respectively as hinge and lock. By analogous process, we'll proceed with the tracing of the holes to be made on the sides of the opening by means of similar telescopic side extension of the device that, because of the independent extensions towards right or left, will avoid any possible irregularity of the span. Then, by equivalent process, we'll definitively fit the grating across the opening.

In practice, the constructing details may, however, vary as regards shape, size, position of elements, and type of materials used, but still remain within the range of the idea proposed as a solution and, consequently, within the limits of the protection granted by this patent for invention.

### BRIEF DESCRIPTION OF DRAWINGS

FIG. 1 shows the exploded view of the device consisting of the telescopic element (1), the hinge-lock ferrules (4), the notch for the registers (5), the left (6) and right (7) extending registers, the left (8) and right (9) spiral rods, the left (10) and right (11) plugs with spiral hole, the rectangular left (10) and right (13) tube, the holes (14) for the TSCE screws (15) fixing the registers, the spiral holes (16) on the plugs, the mobile left (20) and right (19) ends.

FIG. 2 shows the assembled device with relative section, highlighting the span (2) and the jambs (3).

FIG. 3 shows a perspective view of the telescopic elements supporting the grating, with the lock pivot (17), the clutch (18) and the support (23).

FIG. 4 shows the detail of the fixing of the telescopic part to the opening, with the support (23) and the lock pivot (17).

FIG. 5 shows the fitting of a first telescopic element at the base.

FIG. 6 shows a front view of the complete fitting, highlighting the perfect alignment.

FIG. 7 shows a fitted device.

FIG. 8 shows the perfect alignment in a more complex type of opening, with a third telescopic element for an upper fixed part (22) and with the grating (21) below.

FIGS. 9 and 10 shows the compatibility of the invention with different types of opening.

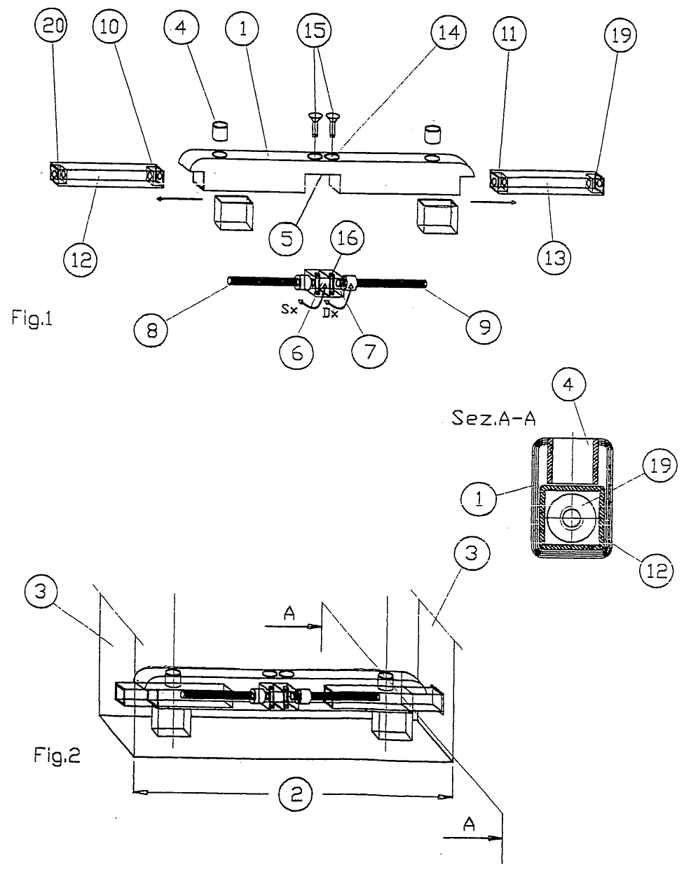

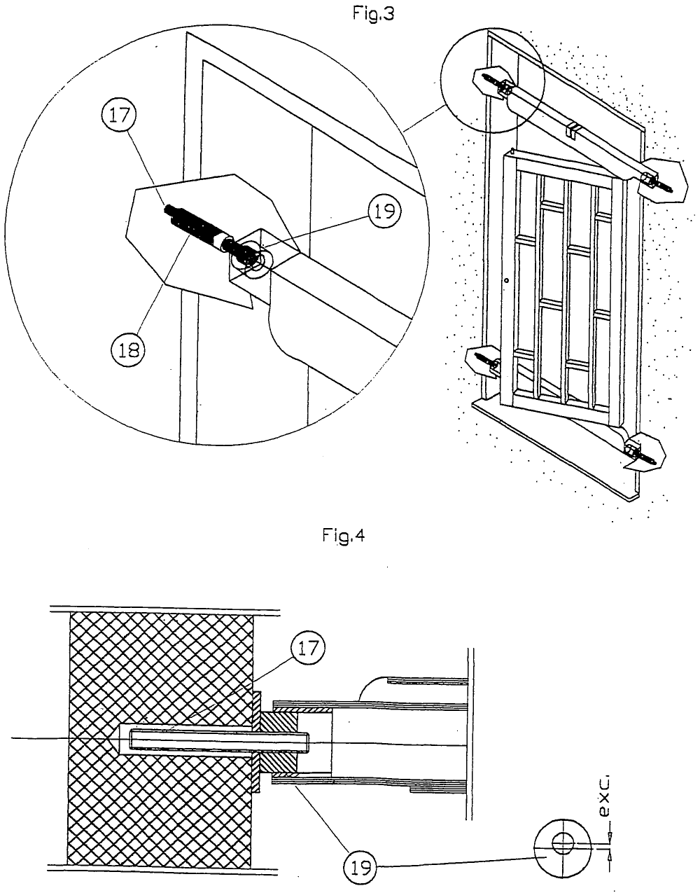

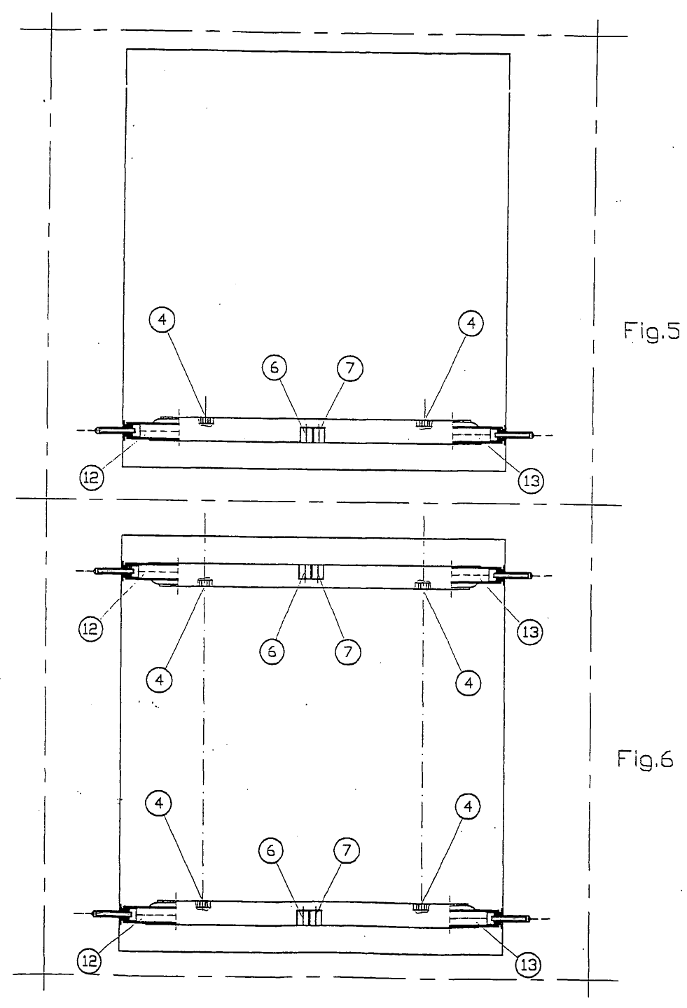

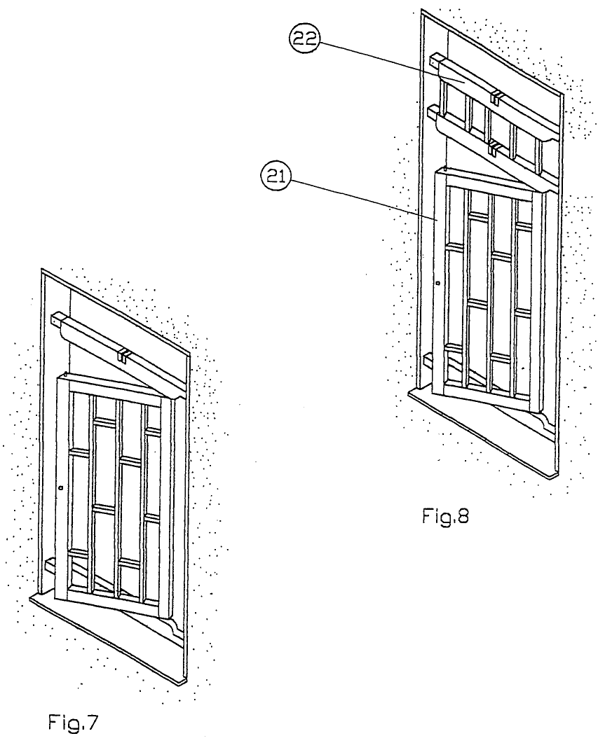

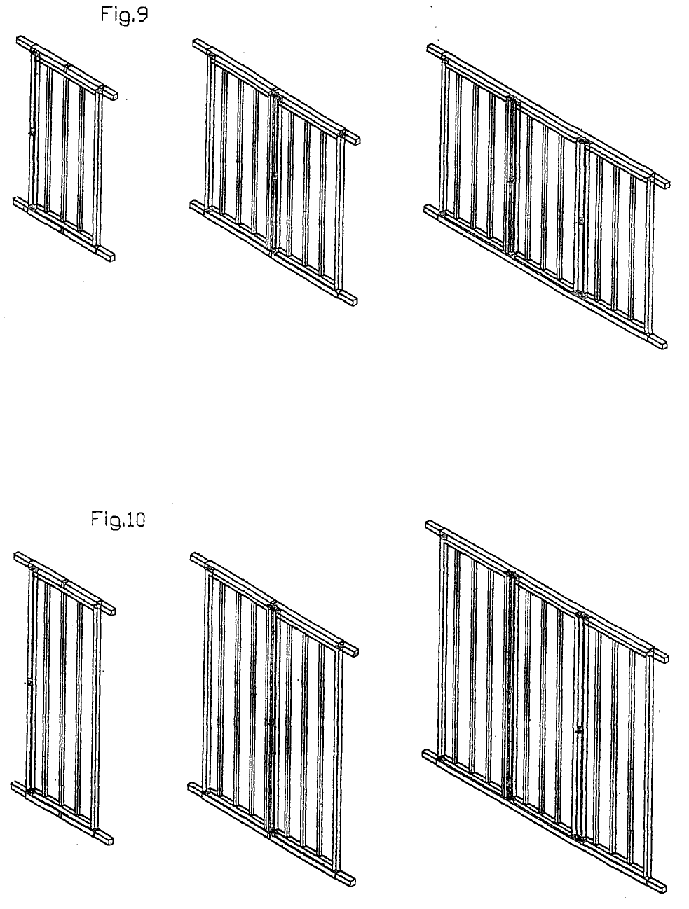

1. Device for the construction and fitting of gratings, characterized by the fact that it comprises:
Means to support the body of the grating, by a rectangular metallic tube shorter than the horizontal or vertical span of the opening across which it must be applied, which is the distance between the two horizontal or vertical jambs. Said tube is provided, along its longitudinal axis, with holes at a distance equivalent to the distance between hinge and lock of the window grating, inside which a number of metallic ferrules are fitted, in order to contain the hinge and lock pivot and act as guide of the telescopic part of the device, since their length has been beforehand calculated to form inside a geometrically compatible guide.
Means to regulate the length of the tube, by a notch at the centre of the tube, where two registers are inserted, which have respectively fitted a spiral rod into the thread of the plugs comprised in the inner part of the components forming the extendable part of the system. These components, led both by the internal plane of the tubing body and, on the opposite side, by the ferrule and the particular shape of the final part of the body of the invention, are pushed by independent rotation of the registers in extension or traction, so that these symmetrical movements allow a perfect position of the device at the centre of the span.
Means to block the registers, by two holes, made on the central body at the vertical axis of the registers, able to block them by means of screws or other means, thanks to a suitable spiral drilling made on the same registers, without causing bulk on the upper part of the device, which will comprise the grating door and/or window.
Means to apply the tube on the sides of the opening across which the grating must be placed, by wall pivots, consisting of a lock pivot to which a support is fixed, which permits the alignment and therefore the insertion of the ends of the telescopic elements constituted by an open ferrule embedded inside their ends.

2. Device according to claim 1, characterized by the fact that the tubes to be applied to the window or other similar opening, are at least two, both placed horizontally or vertically across the opening to be protected and parallel each other.

3. Device according to claim 1, characterized by the fact that on the surface of the tubes facing the inside of the opening across which the grating must be applied, there are a number of ferrules (4) comprising the hinge and lock pivot of the grating. Said grating is constructed in such a way that it can be either kept always closed or opened like a normal window, acting on the axis fixed on the lock pivot that works also as releasing element of the lock.

4. Device according to claim 1, characterized by the fact that the two registers housed in the tube autonomously rotate, so allowing the user to extend or pull one of the two spiral, rods without causing effect on the other or vice versa.

5. Device according to claims 1 and 4, characterized by the fact that the registers can freely rotate around their central axis, causing the spiral rods, joint to them, rotate either in one direction or in the other, respectively extending or pulling the elements connected to the ends of the rods opposite to the ones where the registers are applied.

6. Device according to claim 1, characterized by the fact that, once the registers have been rotated enough to make the spiral rods reach the desired extension, they are locked with suitable lock screws (15), type TSCE, which enter the holes (16) on the outer part of the same register.

7. Device according to claim 1, characterized by the fact that the part of the tube where the lock screws are fixed is later covered with suitable metallic protection, in order to avoid tampering and not to alter the overall aesthetic of the tube.

8. Device according to claim 1, characterized by the fact that, in order to embed the tube in the wall, a lock pivot (17) must be applied to the wall on which the same tube must be fixed, being said pivot (17) possibly equipped, in the case the walls are made of air bricks, with a clutch (18) that contains the injection of the pouring resin.

9. Device according to claim 1, characterized by the fact that the support (23) has an eccentric hole, so that, by rotating, it permits the perfect alignment and insertion of the final parts of the telescopic elements (19, 20), which consist of an open ferrule embedded and soldered inside their ends.

10. Process for the fitting of a grating using the device according to claim 1, characterized by the fact that it comprises the following phases:
insertion of the telescopic element in the lower part of the opening, forming the base, and extension of the telescopic parts towards the walls, in order to accurately locate the drilling point;
drilling of the wall in the tracing point and insertion of the spiral rod or sleeve, by walling it up or sticking it with resin;
placing of the shutter forming the grating on the fitted lower telescopic element, so as to proceed placing the upper telescopic element into the specific holes along the longitudinal axis of the device, properly equipped with metallic embedded ferrule that will act respectively as hinge and lock;
tracing of the holes made on the sides of the opening by means of telescopic side extension of the upper apparatus in a similar way as the one for the lower apparatus;
complete fitting of the grating across the opening.
